(19) United States
(12) Patent Application Publication
(10) Pub. No.: US 2015/0194994 A1
(43) Pub. Date: Jul. 9, 2015

(54) WEATHERPROOF PHONE CASE

(71) Applicant: Superior Communications, Inc., Irwindale, CA (US)

(72) Inventors: Bryan Michael Soriano, Pomona, CA (US); Vivian Wei-Fen Chou, Diamond Bar, CA (US)

(21) Appl. No.: 14/581,661

(22) Filed: Dec. 23, 2014

Related U.S. Application Data
(60) Provisional application No. 61/923,562, filed on Jan. 3, 2014.

(51) Int. Cl. H04B 1/3888

(52) U.S. Cl. CPC H04B 1/3888; H04B 2001/3894

(57) ABSTRACT

A weatherproof phone case including a bottom portion having side walls defining a closed perimeter, the side walls having an outer surface with at least two channels and an inner surface having a flange. The phone case also including a rigid back plate defining a perimeter and having at least two protrusions that travel around at least a portion of the perimeter, the at least two protrusions connectable to the at least two channels, the back plate and the side walls forming a cavity for the placement of a mobile device. The phone case also including a top portion having an outer perimeter, a top surface, an extruding wall extending therefrom and an opening positioned between the top surface and the extruding wall, the top portion configured to fit onto the bottom portion such that the opening receives the flange of the bottom portion. The phone case also including a transparent screen attached to the outer perimeter to allow viewing into the cavity.

### RELATED APPLICATIONS

The present application claims the benefit of U.S. Provisional Application No. 61/923,562, filed Jan. 3, 2014, the entire disclosure of which is incorporated herein by reference.

### BACKGROUND

1. Field of the Invention

The present invention relates to phone cases for protecting the phone from liquid such as water and contaminants such as dust, and more particularly to a phone case having weatherproof features.

2. Description of the Related Art

Many phone cases are currently available. These phone cases, however, are not well-suited to protect the phones or personal electronic devices from liquid such as water and contaminants such as dust. Also, these phone cases may not allow for easy access and use of the buttons and knobs on the phones or personal electronic devices. Accordingly, there is a need for a phone case that is easy to use, weather proof, and allows for better and easier use of the buttons and knobs on a phone or a personal electronic device.

### SUMMARY OF THE INVENTION

A weatherproof phone case including a bottom portion having side walls defining a closed perimeter, the side walls having an outer surface with at least two channels and an inner surface having a flange. The phone case also including a rigid back plate defining a perimeter and having at least two protrusions that travel around at least a portion of the perimeter, the at least two protrusions connectable to the at least two channels, the back plate and the side walls forming a cavity for the placement of a mobile device. The phone case also including a top portion having an outer perimeter, a top surface, an extruding wall extending therefrom and an opening positioned between the top surface and the extruding wall, the top portion configured to fit onto the bottom portion such that the opening receives the flange of the bottom portion. The phone case also including a transparent screen attached to the outer perimeter to allow viewing into the cavity.

### BRIEF DESCRIPTION OF THE DRAWINGS

The features and advantages of the embodiments of the present disclosure will become more apparent from the detailed description set forth below when taken in conjunction with the drawings. Naturally, the drawings and their associated descriptions illustrate example arrangements within the scope of the claims and do not limit the scope of the claims. Reference numbers are reused throughout the drawings to indicate correspondence between referenced elements.

FIG. 1A is a front view of a weatherproof phone case according to an embodiment of the invention.

FIG. 1B is a rear view of a weatherproof phone case according to the embodiment of FIG. 1A.

FIG. 1C is a left side view of a weatherproof phone case according to the embodiment of FIG. 1A.

FIG. 1D is a right side view of a weatherproof phone case according to the embodiment of FIG. 1A.

FIG. 1E is a top view of a weatherproof phone case according to the embodiment of FIG. 1A.

FIG. 1F is a bottom view of a weatherproof phone case according to the embodiment of FIG. 1A.

FIG. 1G is a rear perspective view of a weatherproof phone case according to the embodiment of FIG. 1A.

FIG. 2 is a disassembled front perspective view of the weatherproof phone case shown in FIG. 1 according to an embodiment of the invention.

FIG. 3 is a cross-sectional top view of the weatherproof phone case shown in FIG. 1 according to an embodiment of the invention.

FIGS. 4A and 4B are disassembled rear perspective views of the weatherproof phone case shown in FIG. 1 according to an embodiment of the invention.

FIG. 5 is a left side perspective view of a weatherproof phone case with an actuating mute lever to allow for better weatherproof protection according to an embodiment of the invention.

FIG. 6 is an inner view of the weatherproof phone case of FIG. 5 showing an internal connector for attaching to a phone's mute button according to an embodiment of the invention.

FIGS. 7A and 7B are cross sectional views of the actuating mute lever of the weatherproof phone case of FIG. 5 according to an embodiment of the invention.

### DETAILED DESCRIPTION

In the following detailed description, numerous specific details are set forth to provide an understanding of the present disclosure. It will be apparent, however, to one of ordinarily skilled in the art that elements of the present disclosure may be practiced without some of these specific details. In other instances, well-known structures and techniques have not been shown in detail to avoid unnecessarily obscuring the present disclosure.

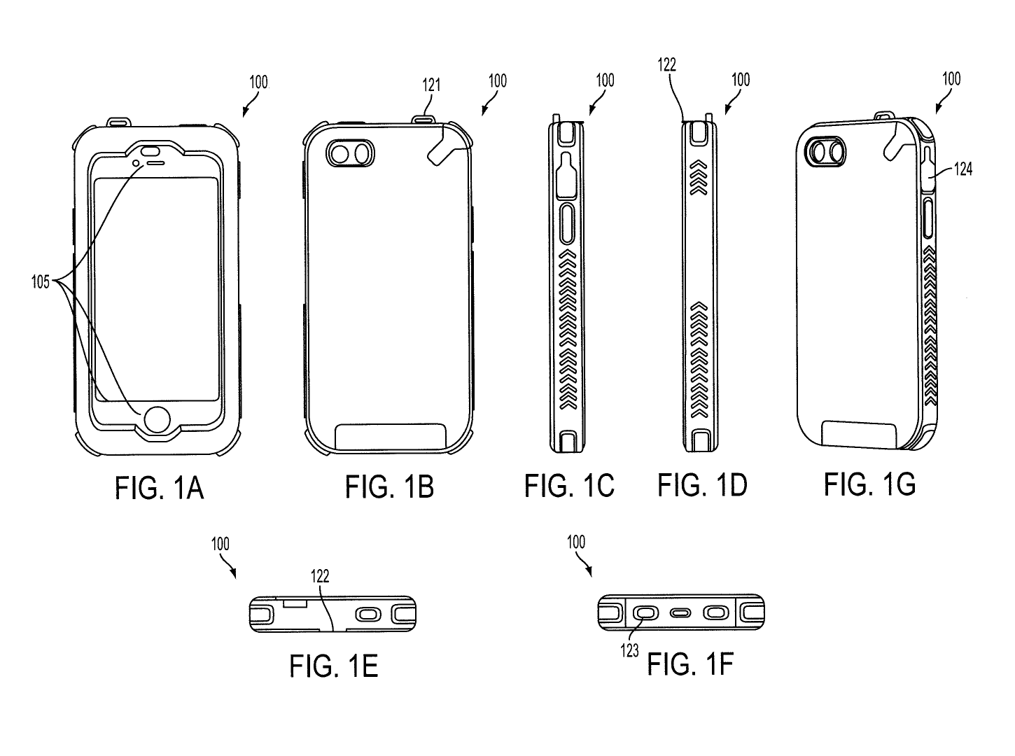

FIG. 1 includes various views of a weatherproof phone case 100 according to an embodiment of the invention. FIG. 1 shows a weatherproof phone case 100 that fits snugly around a phone and provides complete protection of the phone from liquid such as water and contaminants such as dust. The front of the phone may be covered by a thin plastic layer 105 made of Polyethylene Terephthalate (PET), for example. The front phone case cover may also be tinted. In addition, all the buttons and switches on the phone and openings on the phone case are covered for complete protection of the phone.

The weatherproof phone case 100 may include a lanyard hook 121 for allowing a user to tether a lanyard to the phone case 100. The weatherproof phone case 100 may include a pull tab 122 that is configured for a user to pull, to more easily separate a top portion 101 of the case from a bottom portion 102 of the case. The weatherproof case 100 may include a port cover 123 that may be opened or closed to expose or conceal ports of the phone. A button cover 124 may be positioned on the side of the case 100, and may be opened or closed to expose or conceal a button of the phone.

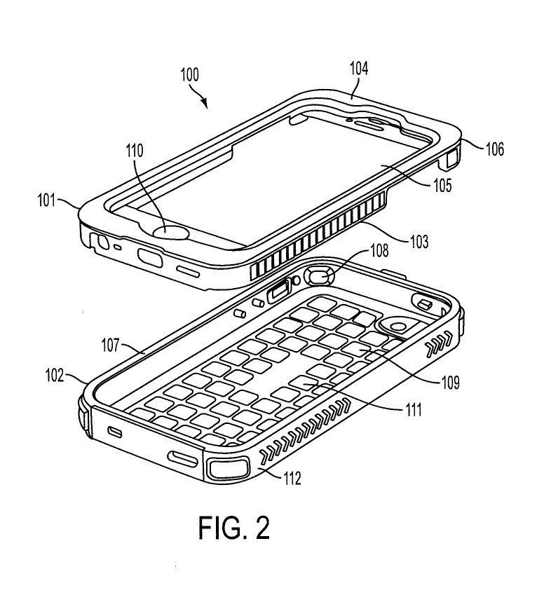

FIG. 2 is a disassembled front perspective view of the weatherproof phone case 100 shown in FIG. 1 according to an embodiment of the invention. The phone case 100 has a top portion 101 and a bottom portion 102. In one embodiment, the top portion 101 has a rigid extrusion 103 extending from a top surface 104 of the top portion 101. The top portion 101 is made of a Polycarbonate (PC) material, for example. The rigid extrusion 103 fits snugly against the inside walls of the bottom portion 102 of the phone case 100. The rigid extrusion 103 helps prevent water leakage to the phone and provides support for the entire phone case 100.

Below the top surface 104 is an interfacing seal 106 that travels around the entire perimeter of the phone case 100. The interfacing seal 106 of the top portion 101 fits on top of an interfacing seal 107 of the bottom portion 102. Therefore, when the top portion 101 fits onto the bottom portion 102, the interfacing seals 106 and 107 create and provide a better water seal around the entire perimeter of the phone case 100 when compared to a rubber o-ring seal or track.

A button portion 110 of the plastic layer 105 is made of a thinner material than the other portions of the plastic layer 105. The thinner material of the button portion 110 allows for better scanning and reading of a finger print that is placed on the button portion 110 of the plastic layer 105. The phone case 100 also has protective corner foam cushions 108 and a silicon padding layer 109 that are made of a softer material. The protective corner foam cushions 108 and the silicon padding layer 109 are co-molded, over molded or integrated with a flexible Thermoplastic Polyurethane (TPU) material that forms the side walls 112 of the phone case 100. A PC material can form a bottom exterior portion 111 with the silicon padding layer formed therein. In one embodiment, the PC material of the bottom exterior portion 111 can be over molded with the TPU material of the side walls 112 to form a more rigid and/or water resistant structure. In one embodiment, the protective corner foam cushions 108 may be inserted into the side walls 112 of the case at respective corners. In one embodiment, the silicon padding layer 109 may be glued to the case with an adhesive. In one embodiment, the protective cushions may be made of rubber, or other suitable cushioning materials.

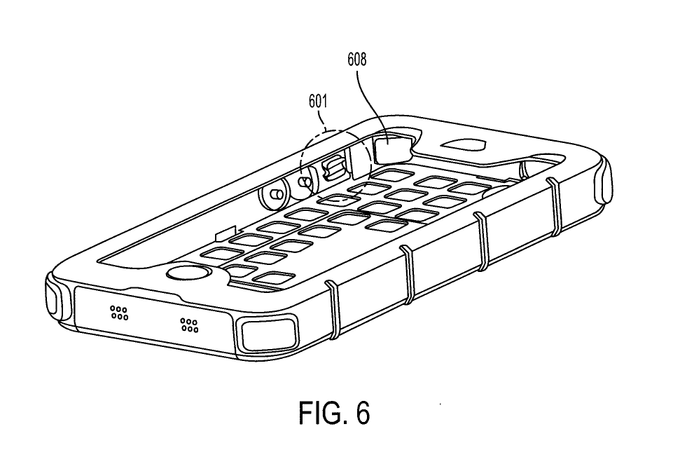

In one embodiment, the protective corner foam cushions 108 may be positioned at the corners of the bottom portion 102. In one embodiment, the protective foam cushions 608 may be positioned at the corners of the top portion, as shown in FIG. 6. The protective corner foam cushions may be inserted into the side walls of the top portion of the case at respective corners. The top portion 101 may be configured to include corner foam cushions 108 that extend in a direction towards the interior cavity of the case. In one embodiment in which the top portion 101 includes the foam cushions 108, the bottom portion 102 may lack foam cushions that extend in a direction towards the interior cavity of the case.

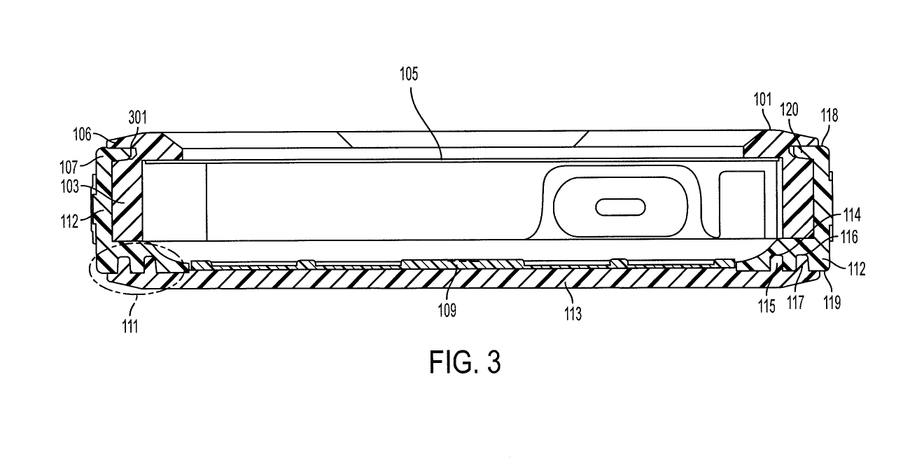

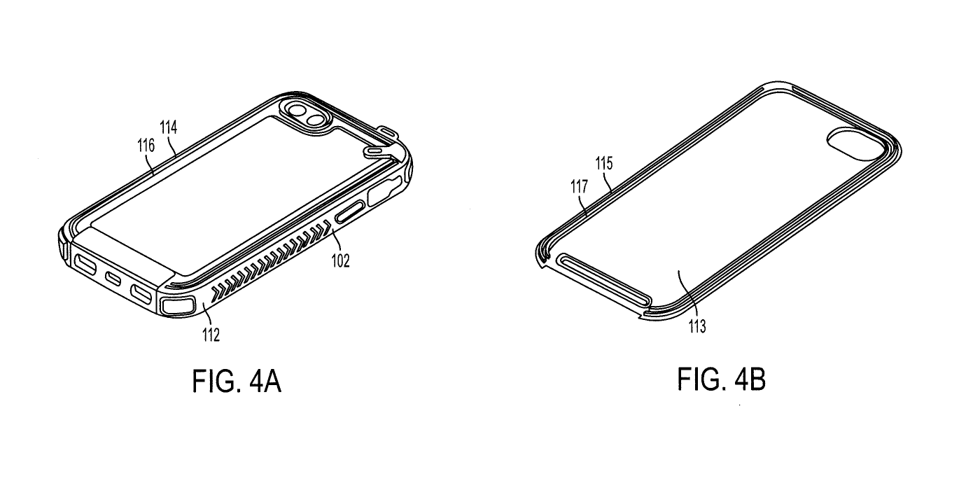

FIG. 3 is a cross-sectional top view of the weatherproof phone case shown in FIG. 1 according to an embodiment of the invention. As shown, the interfacing seal 106 of the top portion 101 has a cutout 301 along the entire perimeter for snugly receiving the interfacing seal 107. This creates and provides a better water seal around the entire perimeter of the phone case 100. Also, as shown, the rigid extrusion 103 fits snugly against the inside walls 112 of the bottom portion 102 of the phone case 100. The walls 112 have an inner surface 118 with a flange 120 extending towards the cavity and an outer surface 119 having at least two channels 114 and 116. The walls 112 being made out of a flexible material advantageously allows the walls 112 to bend or flex to allow the rigid extrusion 103 to be inserted into the cavity of the bottom portion 102 of the phone case 100. A rigid back plate 113 may be snapped or fastened to the walls 112. In one embodiment, the walls 112 have two channels or grooves 114 and 116 and the back plate 113 has two protrusions 115 and 117 that fit into the two channels 114 and 116 (see also FIG. 4). In one embodiment, the back plate 113 may be co-molded to the walls 112.

As shown in FIG. 3, the flange 120 may extend from an upper end of the respective side walls 112.

FIG. 4 is a disassembled rear perspective view of the weatherproof phone case shown in FIG. 1 according to an embodiment of the invention. The rigid back plate 113 has been removed from the bottom portion 102 to better show the two channels 114 and 116 and the two protrusions 115 and 117. The two channels 114 and 116 and the two protrusions 115 and 117 travel substantially around the entire perimeter of the phone case 100. When the back plate 113 is attached to the walls 112, the two channels 114 and 116 and the two protrusions 115 and 117 allow for a good weatherproof seal.

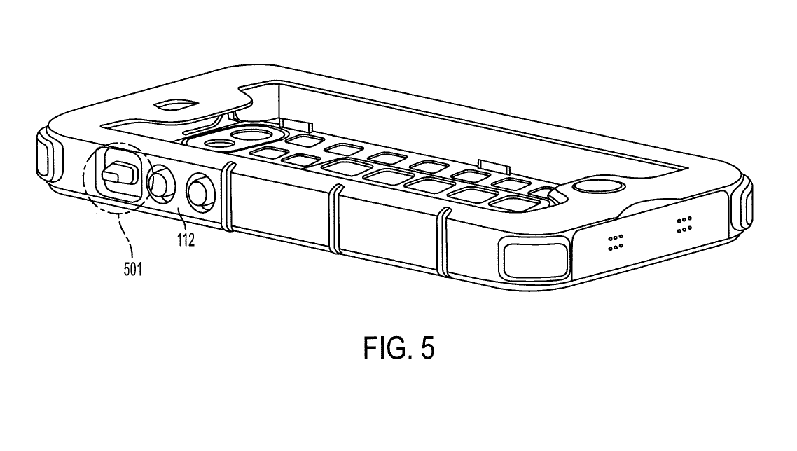

FIG. 5 is a left side perspective view of the weatherproof phone case 100 shown in FIG. 1 with an actuating mute lever 501 to allow for better weatherproof protection according to an embodiment of the invention. The actuating mute lever 501 protrudes outward away from the wall 112.

FIG. 6 is an inner view of the weatherproof phone case 100 of FIG. 1 showing an internal connector 601 for attaching to a phone's mute button according to an embodiment of the invention. The internal connector 601 is sized and configured to secure to the phone's mute button such that up and down movement of the actuating mute lever 501 causes the phone's mute button to be activated and deactivated, accordingly.

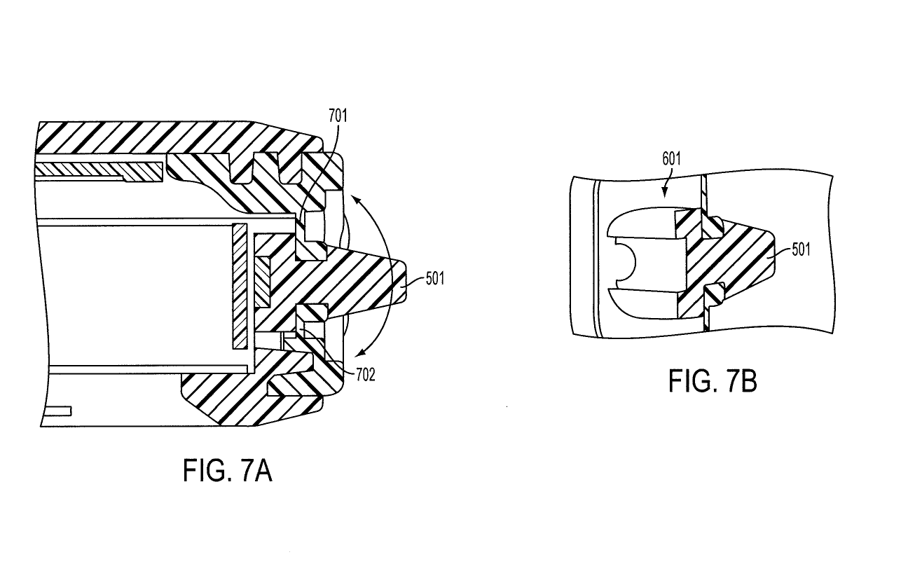

FIG. 7 is a cross sectional view of the actuating mute lever 501 of the weatherproof phone case 100 of FIG. 1 according to an embodiment of the invention. As shown, portions 701 and 702 (identified as thin flexible TPU wall) move up and down as the actuating mute lever 501 moves up and down while still providing a water seal at the location of the actuating mute lever 501. This allows the actuating mute lever 501 to be sealed and covered. Accordingly, the lever 501 may operate a lever of the phone.

The foregoing description of the disclosed example embodiments is provided to enable any person of ordinary skill in the art to make or use the present invention. Various modifications to these examples will be readily apparent to those of ordinary skill in the art, and the principles disclosed herein may be applied to other examples without departing from the spirit or scope of the present invention. The described embodiments are to be considered in all respects only as illustrative and not restrictive and the scope of the invention is, therefore, indicated by the following claims rather than by the foregoing description. All changes which come within the meaning and range of equivalency of the claims are to be embraced within their scope.

What is claimed is:

1. A weatherproof phone case, comprising:
a bottom portion having side walls defining a closed perimeter, the side walls having an outer surface with at least two channels and an inner surface having a flange;
a rigid back plate defining a perimeter and having at least two protrusions that travel around at least a portion of the perimeter, the at least two protrusions connectable to the at least two channels, the back plate and the side walls forming a cavity for the placement of a mobile device;
a top portion having an outer perimeter, a top surface, an extruding wall extending therefrom and an opening positioned between the top surface and the extruding wall, the top portion configured to fit onto the bottom portion such that the opening receives the flange of the bottom portion; and
a transparent screen attached to the outer perimeter to allow viewing into the cavity.

2. The case of claim 1, wherein the flange extends towards the cavity.

3. The case of claim 1, wherein the flange and the opening are configured to form a seal along the entire perimeter of the case when the opening receives the flange.

4. The case of claim 1, wherein the side walls are made of a flexible material, and the extruding wall is made of a material that is more rigid than the flexible material.

5. The case of claim 4, wherein the rigid back plate is made of a material that is more rigid than the flexible material.

6. The case of claim 5, wherein the rigid back plate is made of polycarbonate, and the flexible material is thermoplastic polyurethane.

7. The case of claim 1, wherein the extruding wall is configured to fit snugly against the inner surface when the top portion fits onto the bottom portion.

8. The case of claim 1, wherein the at least two protrusions travel substantially around the entire perimeter of the rigid back plate.

9. The case of claim 1, further comprising a padding layer positioned upon the rigid back plate.

10. The case of claim 1, wherein the side walls are configured to flex to allow the top portion to fit onto the bottom portion.

11. A weatherproof case for a mobile device, comprising:
a bottom portion having a back plate and side walls, the side walls extending away from the back plate such that the back plate and the side walls form a cavity for receiving the mobile device;
at least one flange extending from the sidewalls towards the cavity;
a top portion having a top surface and side walls extending away from the top surface, the side walls including at least one cutout, the top portion configured to be received by the bottom portion such that the side walls of the top portion are positioned in the cavity and the at least one cutout receives the at least one flange.

12. The case of claim 11, wherein the at least one flange travels around the entire perimeter of the bottom portion.

13. The case of claim 11, wherein the at least one cutout travels around the entire perimeter of the top portion.

14. The case of claim 11, wherein the at least one flange extends from an inner surface of the side walls of the bottom portion.

15. The case of claim 11, wherein the side walls of the bottom portion extend away from the backplate to an upper end of the respective side wall, the at least one flange extending from the upper end of each of the respective side walls.

16. The case of claim 11, wherein the at least one cutout is configured to receive the at least one flange such that the at least one cutout and the at least one flange form a water seal around the entire perimeter of the top portion.

17. The case of claim 11, wherein each of the side walls includes an inner surface, the side walls of the top portion configured to fit snugly against the inner surface of each of the side walls when the top portion is received by the bottom portion.

18. The case of claim 11, further comprising a transparent screen coupled to the top portion and configured to cover a screen of the mobile device when the mobile device is received by the cavity.

19. The case of claim 11, wherein the side walls have an outer surface with at least two channels, and the back plate has at least two protrusions that travel around at least a portion of the perimeter of the back plate and are received by the at least two channels.

20. The case of claim 11, wherein at least one of the side walls of the bottom portion is made of a flexible material and is molded to a lever that is more rigid than the flexible material, the lever configured to operate a lever of the mobile device when the mobile device is received by the cavity.
